(19) United States
(12) Patent Application Publication
(10) Pub. No.: US 2017/0195664 A1
(43) Pub. Date: Jul. 6, 2017

(54) THREE-DIMENSIONAL VIEWING ANGLE SELECTING METHOD AND APPARATUS

(71) Applicant: Beijing Pico Technology Co., Ltd., Beijing (CN)

(72) Inventor: Hongcai Li, Beijing (CN)

(21) Appl. No.: 15/254,172

(22) Filed: Sep. 1, 2016

(30) Foreign Application Priority Data
Dec. 31, 2015 (CN) 201511021519.9

(51) Int. Cl. H04N 13/04; G06T 7/00

(52) U.S. Cl. CPC H04N 13/0445; H04N 13/0429; H04N 13/0425; G06T 7/004

(57) ABSTRACT

The present invention discloses a three-dimensional viewing angle selecting method, comprising: providing two virtual cameras for simulating a viewing angle; capturing visual feature information of a user, and providing a virtual cursor based on the visual feature information; selecting a positional coordinate based on the virtual cursor; receiving a confirmation signal input by the user; after receiving the confirmation signal, moving the two virtual cameras to two sides of the positional coordinate; and displaying a virtual scene captured by the two virtual cameras. The present invention also provides a three-dimensional viewing angle selecting apparatus. The three-dimensional viewing angle selecting method of the present invention can allow users to view from multiple selected angles, thereby enhancing the user experience.

### CROSS-REFERENCE TO RELATED APPLICATIONS

This application claims priority to Chinese Patent Application No. 201511021519.9 filed on Dec. 31, 2015, the entire disclosure of which is hereby specifically and entirely incorporated by reference.

### FIELD OF THE INVENTION

The present invention relates to the field of virtual reality, and particularly to a three-dimensional (3D) viewing angle selecting method and apparatus.

### BACKGROUND OF THE INVENTION

A virtual reality technology is a computer simulation system that can create and experience a virtual world. The system generates a virtual environment using a computer, is an interactive system that integrates multiple-source information and integrates 3D dynamic visual scenes and real actions, and submerges users into the virtual environment through simulation.

Current virtual reality technologies develop quickly, and are mainly applied to the fields of movies, TV programs and games. In order to achieve an effect of viewing on site in watching movies and TV programs, users in real life are simulated, and positions of users can be moved according to personal interests such that the movies can be viewed from multiple viewing angles.

In the prior art, when movies are watched using a head-mounted virtual reality device, relative positions of the user and the virtual reality device are fixed, the vision and the viewing angle that the eyes of the user can see are limited, such that the user cannot roam in the virtual world. That is, users can only view movies from limited viewing angles, and cannot experience viewing movies from multiple viewing angles as they do in real movie theatres.

Therefore, a novel method and apparatus need to be provided to allow users to view from different viewing angles.

### SUMMARY OF THE INVENTION

An objective of the present invention is to provide novel technical solutions for a three-dimensional viewing angle selecting method and apparatus.

According to a first aspect of the present invention, there is provided a three-dimensional viewing angle selecting method, comprising: providing two virtual cameras for simulating a viewing angle; capturing visual feature information of a user, and providing a virtual cursor based on the visual feature information; selecting a positional coordinate based on the virtual cursor; receiving a confirmation signal input by the user; after receiving the confirmation signal, moving the two virtual cameras to two sides of the positional coordinate; and displaying a virtual scene captured by the two virtual cameras.

Preferably, said selecting a positional coordinate based on the virtual cursor comprises: selecting a positional coordinate of a first selectable position, which is reached by a line determined by the virtual cursor in the virtual scene towards an inner side of a screen.

Preferably, the virtual scene is a virtual movie theatre, and the positional coordinate is a positional coordinate of a virtual seat in the virtual movie theatre.

Preferably, the virtual cursor comprises a virtual cursor graph and virtual cursor positional information.

According to a second aspect of the present invention, there is provided a three-dimensional viewing angle selecting apparatus, comprising: a virtual camera providing module configured to provide two virtual cameras for simulating a viewing angle; a visual feature capturing module configured to capture visual feature information of a user and provide a virtual cursor based on the visual feature information; a positional coordinate selecting module configured to select positional coordinate based on the virtual cursor; a positional coordinate confirmation module configured to receive a confirmation signal input by the user; a virtual camera moving module configured to move the two virtual cameras to two sides of the positional coordinate after receiving the confirmation signal; and a display module configured to display a virtual scene captured by the two virtual cameras.

Preferably, the positional coordinate selecting module is configured to select a positional coordinate of a first selectable position, which is reached by a line determined by the virtual cursor in the virtual scene towards an inner side of a screen.

Preferably, the positional coordinate confirmation module comprises an external input device and/or a triggering module; the external input device comprises a Bluetooth handle and/or a touch panel; and the triggering module is configured to trigger a confirmation operation of the positional coordinate after a predetermined period lapses.

Preferably, the virtual scene is a virtual movie theatre, and the positional coordinate is a positional coordinate of a virtual seat in the virtual movie theatre.

Preferably, the virtual cursor comprises a virtual cursor graph and virtual cursor positional information.

The inventor(s) of the present invention find(s) that in the prior art, usually users' positions are fixed when watching movies using virtual reality devices, such that the viewing angles cannot be selected freely. However, in the present invention, users can select their positions in a virtual scene before watching movies, such as a virtual seal in a virtual movie theatre, so that the users can select viewing angles for watching movies. Therefore, the technical problem to be solved by the present invention is not anticipated by those skilled in the art, and the present invention includes novel technical solutions.

Other features and advantages of the present invention will become apparent through the detailed descriptions of the embodiments of this invention with reference to the drawings.

### BRIEF DESCRIPTION OF THE DRAWINGS

The drawings that are integrated into the description and constitute a part of the description show the embodiments of the present invention and are intended to explain the principle of the invention together with the descriptions thereof.

FIG. 1 shows a flowchart of a three-dimensional viewing angle selecting method according to an embodiment of this invention.

FIG. 2 is a schematic view of a three-dimensional viewing angle selecting apparatus according to an embodiment of this invention.

FIG. 3 is a schematic view showing a three-dimensional viewing angle selecting process according to an embodiment of this invention.

### DETAILED DESCRIPTION OF THE EMBODIMENTS

Now, various embodiments of this invention will be described in detail with reference to the drawings. It should be noted that, unless specified otherwise, the arrangements of the members and steps, the mathematical formulas and numerical values described in these embodiments do not restrict the scope of the invention.

The following descriptions for at least one embodiment are actually descriptive only, and shall not be intended to limit the invention and any application or use thereof.

The techniques, methods and devices well known to those skilled in the related arts may not be discussed in detail. However, where applicable, such techniques, methods and devices should be deemed as a part of the description.

Any specific value shown herein and in all the examples should be interpreted as illustrative only rather than restrictive. Therefore, other examples of the embodiments may include different values.

It should be noted that similar signs and letters in the following drawings represent similar items. Therefore, once defined in one drawing, an item may not be further discussed in the followed drawings.

The present invention provides a three-dimensional viewing angle selecting method, which may be used in various 3D display devices, such as head-mounted 3D display devices, tablets, cell phones or TVs. The 3D display device may use naked eye 3D display technologies or glasses type 3D display technologies. The naked eye 3D display technologies may use raster lens or night lens, which will not be limited in this invention.

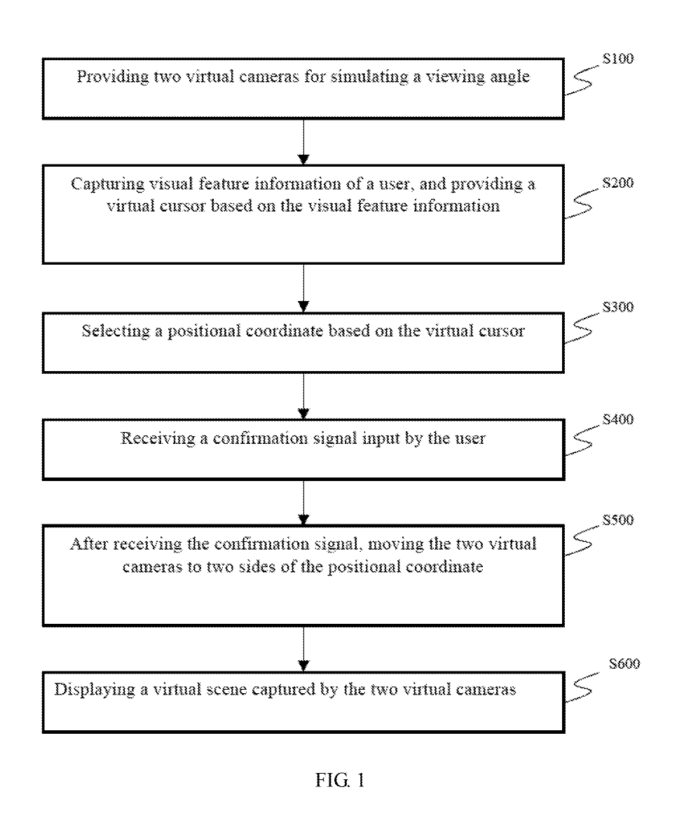

FIG. 1 shows a flowchart of a three-dimensional viewing angle selecting method according to this invention.

In step S100, two virtual cameras are provided for simulating a viewing angle. A virtual camera is a tool used in a virtual reality environment to simulate a user's viewing angle and sight field, and may be a software module. If a virtual reality display device used by the user displays content in split screens, the scenes captured by the two virtual cameras can be displayed in the two parts of the split screens respectively.

In step S200, visual feature information of a user is captured, and a virtual cursor is provided based on the visual feature information. In this process, the user's sight line is tracked by using the software module. The virtual cursor is determined based on an intersection of a midline of the sight lines of the user's eyes and the screen. The virtual cursor includes a cross cursor graph in the virtual reality environment and its positional information. Sight line capturing belongs to the prior art, and has been widely used.

In step S300, a positional coordinate is selected based on the virtual cursor. This process may include selecting a positional coordinate of a first selectable position, which is reached by a line determined by the virtual cursor in the virtual scene towards an inner side of a screen. That is, the user controls a position of the virtual cursor using a sight line tracking technique, and then the virtual cursor selects the positional coordinate of a selectable position along a line determined by the virtual cursor.

In step S400, a confirmation signal input by the user is received. The confirmation signal may be sent by an external device controlled by the user. For example, the confirmation signal input by the user may be received by a Bluetooth handle and/or a touch panel or other devices. The confirmation signal may be sent by a triggering module, which is configured to trigger a confirmation operation of the positional coordinate after a predetermined time period lapses. Specifically, the user's sight line may be controlled to stay at the positional coordinate of a selectable position using a sight line capturing technique; then, if the user's sight line stays at the positional coordinate for 5 seconds, the triggering module will confirm the positional coordinate of that position.

In step S500, after receiving the confirmation signal, the two virtual cameras are moved to two sides of the positional coordinate. That is, after receiving the confirmation signal input by the user in the last step, the positional coordinate are determined, then the two virtual cameras are moved to be near the positional coordinate. As the virtual cameras are intended to simulate the user's viewing angle, this step has achieved the objective of moving the viewing angle to a selected position.

In step S600, a virtual scene captured by the two virtual cameras is displayed. The ultimate objective of this invention is to display a scene captured by the virtual cameras at the selected position on the screen. Therefore, after the position is selected, a virtual scene captured by the two virtual cameras after the two virtual cameras are moved needs to be displayed.

In the above steps, the virtual scene may be a virtual movie theatre, and the positional coordinate may be positional coordinate of a virtual seat in the virtual movie theatre. In this case, the user simulates audience in a movie theatre, and selects a seat in a virtual movie theatre with a cursor using a sight line tracking technique; and then the virtual cameras are moved to two sides of the selected seat, so that the user can experience a process of watching movies from different viewing angles.

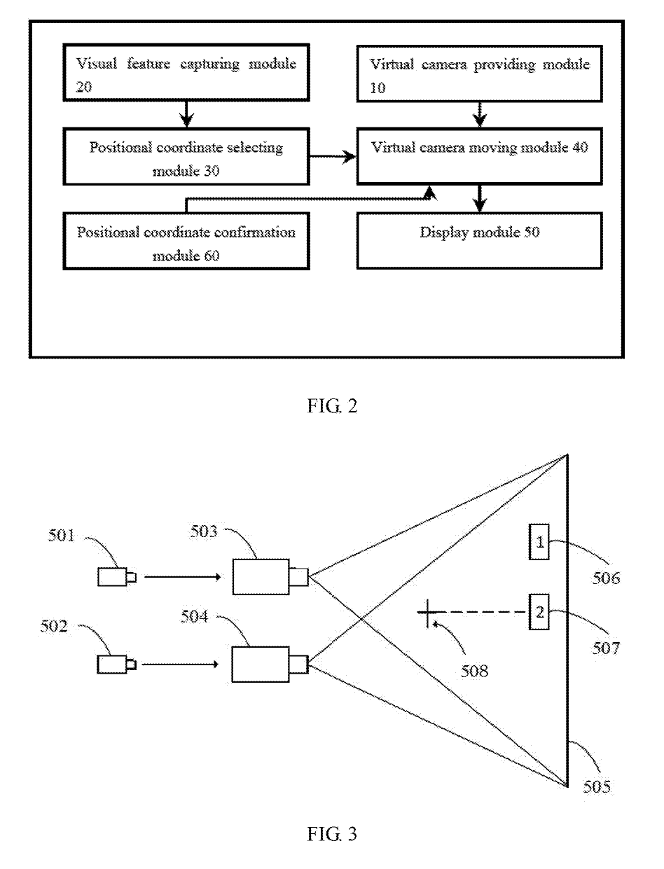

This invention further provides a three-dimensional viewing angle selecting apparatus. As shown in FIG. 2, the apparatus comprises a virtual camera providing module 10, a visual feature capturing module 20, a positional coordinate selecting module 30, a virtual camera moving module 40, a display module 50 and a positional coordinate confirmation module 60.

The virtual camera providing module 10 is configured to provide two virtual cameras for simulating a viewing angle. A virtual camera is a tool used in a virtual reality environment to simulate a user's viewing angle and sight field, and may be a software module. If a virtual reality display device used by the user displays content in split screens, the scenes captured by the two virtual cameras can be displayed in the two parts of the split screens respectively.

The visual feature capturing module 20 is configured to capture visual feature information of a user and provide a virtual cursor based on the visual feature information. In this process, the user's sight line is tracked by using the software module. The virtual cursor is determined based on an intersection of a midline of the sight lines of the user's eyes and the screen. The virtual cursor includes a cross cursor graph in the virtual reality environment and its positional information.

The positional coordinate selecting module 30 is configured to select positional coordinate based on the virtual cursor. This process may include selecting a positional coordinate of a first selectable position, which is reached by a line determined by the virtual cursor in the virtual scene towards an inner side of a screen. That is, the user controls a position of the virtual cursor using a sight line tracking technique, then the virtual cursor selects the positional coordinate of a selectable position along a line determined by the virtual cursor.

The positional coordinate confirmation module 60 is configured to receive a confirmation signal input by the user. The positional coordinate confirmation module 60 may be an external device, such as a Bluetooth handle and/or a touch panel or other devices. The positional coordinate confirmation module 60 may be a triggering module, which is configured to trigger a confirmation operation of the positional coordinate after a predetermined time period lapses.

The virtual camera moving module 40 is configured to move the two virtual cameras to two sides of the positional coordinate after receiving a signal confirming the positional coordinate. The positional coordinate confirmation module 60 confirms the positional coordinate. Then, the two virtual cameras are moved to positions corresponding to the positional coordinate. As the virtual cameras are intended to simulate the user's viewing angle, this apparatus has achieved the objective of moving the viewing angle to a selected position.

The display module 50 is configured to display a virtual scene captured by the two virtual cameras. An objective of this invention is to display a scene captured by the virtual cameras at the selected position on the screen. Therefore, after the position is selected, a virtual scene captured by the two virtual cameras after the two virtual cameras are moved shall be displayed by the display module 50.

FIG. 3 is a schematic view showing a three-dimensional viewing angle selecting process according to an embodiment of this invention.

Numbers 501 and 502 respectively represent the left eye and the right eye of a user; numbers 503 and 504 respectively represent virtual cameras; number 508 represents a virtual cursor; number 505 represents a virtual scene captured by the virtual cameras; number 506 represents a first position; and number 507 represents a second position.

The virtual cameras 503, 504 are provided by the virtual camera providing module.

The left eye 501 and the right eye 502 of the user determine the virtual cursor 508 using sight line tracing software. The virtual cursor 508 may include a cross-shaped graph and its position. This process is performed by the visual feature capturing module.

In the virtual scene 505, as the user's sight line moves, the position of the virtual cursor 508 moves. In this process, the positional coordinate of a first selectable position reached by the virtual cursor 508 along the dotted line in FIG. 3 is the second position 507, so that the second position 507 is selected. This process is performed by the positional coordinate selecting module. At this time, the user may press a key on the Bluetooth handle to confirm the result. The Bluetooth handle as the positional coordinate confirmation module receives a confirmation signal from the user. If the user confirms the second position 507, the virtual camera moving module moves the two virtual cameras 503, 504 to two sides of the second position. Then, the display module displays a virtual scene captured by the two virtual cameras 503, 504.

The virtual scene 505 may be a virtual movie theatre. The number 506 may represent a first seat, and the number 507 may represent a second seat. In this embodiment, the second seat is selected by the user, so that the user can watch movies at the viewing angle of the second seat. Thus, different manners are provided to watch movies, and users can watch movies from different viewing angles, thereby enhancing users' interest and improving the user experience.

Those skilled in the art shall understand that the above apparatus may be realized by various means. For example, the above apparatus may be realized by configuring a processor using instructions. For example, the instructions may be stored in a read-only memory (ROM), and may be read into a programmable device to realize the above apparatus when the device starts. For example, the above apparatus may be consolidated in a specific device (such as an application specific integrated circuit (ASIC)). The above apparatus may be divided into independent units, or may be realized by combining the units. The above apparatus may be realized by one or more of the above manners, which are equivalents to a person skilled in the art.

Those skilled in the art shall well know that, as electronic and information technologies such as large scale integrated circuit technologies develop and the trend that software are realized by hardware advances, it becomes difficult to distinguish software and hardware of computer systems, since any operation or execution of any instruction can be realized by software or hardware. Whether to realize a function of a machine using a software or hardware solution may depend on non-technical factors such as prices, speeds, reliability, storage capacity, change period etc. Therefore, a more direct and clear description manner of a technical solution to a person skilled in the fields of electronic and information technologies may be descriptions of the operations of the solution. When knowing the operations to be performed, those skilled in the art may directly design desired products based on considerations of the non-technical factors.

Although specific embodiments of this invention are described in detail through some examples, those skilled in the art shall understand that the above examples are explanatory only and are not intended to limit the scope of the invention, that modifications can be made to the above embodiments without departing from the scope and spirit of the invention, and that the scope of the invention is defined by the appended claims.

What is claimed is:

1. A three-dimensional viewing angle selecting method comprising:
providing two virtual cameras for simulating a viewing angle;
capturing visual feature information of a user, and providing a virtual cursor based on the visual feature information;
selecting a positional coordinate based on the virtual cursor;
receiving a confirmation signal;
after receiving the confirmation signal, moving the two virtual cameras to two sides of the positional coordinate; and
displaying a virtual scene captured by the two virtual cameras.

2. The three-dimensional viewing angle selecting method of claim 1, wherein the selecting of a positional coordinate based on the virtual cursor comprises selecting a positional coordinate of a first selectable position, wherein the first selectable position is reached by a line determined by the virtual cursor in the virtual scene towards an inner side of a screen.

3. The three-dimensional viewing angle selecting method of claim 1, wherein the virtual scene is a virtual movie theatre, and the positional coordinate is a positional coordinate of a virtual seat in the virtual movie theatre.

4. The three-dimensional viewing angle selecting method of claim 1, wherein the virtual cursor comprises a virtual cursor graph and virtual cursor positional information.

5. A three-dimensional viewing angle selecting apparatus comprising:
a virtual camera providing module configured to provide two virtual cameras for simulating a viewing angle;
a visual feature capturing module configured to capture visual feature information of a user and provide a virtual cursor based on the visual feature information;
a positional coordinate selecting module configured to select a positional coordinate based on the virtual cursor;
a positional coordinate confirmation module configured to receive a confirmation signal;
a virtual camera moving module configured to move the two virtual cameras to two sides of the positional coordinate after receiving the confirmation signal; and
a display module configured to display a virtual scene captured by the two virtual cameras.

6. The three-dimensional viewing angle selecting apparatus of claim 5, wherein the positional coordinate selecting module is further configured to select a positional coordinate of a first selectable position, wherein the first selectable position is reached by a line determined by the virtual cursor in the virtual scene towards an inner side of a screen.

7. The three-dimensional viewing angle selecting apparatus of claim 5, wherein the positional coordinate confirmation module comprises an external input device, wherein the external input device comprises a Bluetooth handle.

8. The three-dimensional viewing angle selecting apparatus of claim 5, wherein the positional coordinate confirmation module comprises an external input device, the external input device comprises a touch panel.

9. The three-dimensional viewing angle selecting apparatus of claim 5, wherein the positional coordinate confirmation module comprises a triggering module, the triggering module configured to trigger a confirmation operation of the positional coordinate after a predetermined period lapses.

10. The three-dimensional viewing angle selecting apparatus of claim 5, wherein the virtual scene is a virtual movie theatre, and the positional coordinate is a positional coordinate of a virtual seat in the virtual movie theatre.

11. The three-dimensional viewing angle selecting apparatus of claim 5, wherein the virtual cursor comprises a virtual cursor graph and virtual cursor positional information.
